(19) United States
(12) Patent Application Publication
(10) Pub. No.: US 2024/0307776 A1
(43) Pub. Date: Sep. 19, 2024

(54) METHOD AND APPARATUS FOR DISPLAYING INFORMATION IN VIRTUAL SCENE, ELECTRONIC DEVICE, STORAGE MEDIUM, AND COMPUTER PROGRAM PRODUCT

(71) Applicant: Tencent Technology (Shenzhen) Company Limited, Shenzhen (CN)

(72) Inventors: Weixiang YU, Shenzhen (CN); Yun YANG, Shenzhen (CN)

(21) Appl. No.: 18/674,643

(22) Filed: May 24, 2024

Related U.S. Application Data
(63) Continuation of application No. PCT/CN2023/092015, filed on May 4, 2023.

(30) Foreign Application Priority Data
Jul. 14, 2022 (CN) 202210834522.6

(51) Int. Cl. A63F 13/533; A63F 13/52; A63F 13/822

(52) U.S. Cl. CPC A63F 13/533; A63F 13/52; A63F 13/822; A63F 2300/6653

(57) ABSTRACT

This application provides a method for displaying information in a virtual scene performed by an electronic device. The method includes: displaying scene auxiliary information of the virtual scene and an operation control of the virtual scene, the operation control being configured to control an action of a virtual object in the virtual scene; while adjusting content in a field of view of the virtual object in response to an adjustment operation of the field of view of the virtual object through the operation control: adjusting visibility of the scene auxiliary information, wherein the adjusted visibility of the scene auxiliary information is lower than visibility of the operation control; and restoring the visibility of the scene auxiliary information when the adjustment operation of the field of view ends.

### CROSS-REFERENCE TO RELATED APPLICATIONS

This application is a continuation application of PCT Patent Application No. PCT/CN2023/092015, entitled “METHOD AND APPARATUS FOR DISPLAYING INFORMATION IN VIRTUAL SCENE, ELECTRONIC DEVICE, STORAGE MEDIUM, AND COMPUTER PROGRAM PRODUCT” filed on May 4, 2023, which is based upon and claims priority to Chinese Patent Application No. 2022108345226, entitled “METHOD AND APPARATUS FOR DISPLAYING INFORMATION IN VIRTUAL SCENE, ELECTRONIC DEVICE, STORAGE MEDIUM, AND COMPUTER PROGRAM PRODUCT” filed on Jul. 14, 2022, both of which are incorporated herein by reference in their entirety.

### FIELD OF THE TECHNOLOGY

This application relates to the field of virtualization and human-computer interaction technologies, and in particular, to a method and apparatus for displaying information in a virtual scene, an electronic device, a computer-readable storage medium, and a computer program product.

### BACKGROUND OF THE DISCLOSURE

A display technology based on graphics processing hardware expands a channel for perceiving an environment and obtaining information, especially a multimedia technology of a virtual scene; implements a diversified interaction between virtual objects that is controlled by users or artificial intelligence based on an actual implementation need by using a human-computer interaction engine technology; and has various typical application scenarios, for example, in a game scene, can simulate an actual interaction process between the virtual objects.

In the related art, in an interface of the virtual scene, a large amount of complex information such as various function entrances, controls, and prompts is displayed. This affects checking and operation by the user in the virtual scene, and reduces human-computer interaction efficiency.

### SUMMARY

The embodiments of this application provide a method and apparatus for displaying information in a virtual scene, an electronic device, a computer-readable storage medium, and a computer program product. This can reduce complexity of information display, and improve utilization of display resources and human-computer interaction efficiency.

Technical solutions in the embodiments of this application are implemented as follows.

An embodiment of this application provides a method for displaying information in a virtual scene performed by an electronic device, the method including:
displaying scene auxiliary information of the virtual scene and an operation control of the virtual scene, the operation control being configured to control an action of a virtual object in the virtual scene;
while adjusting content in a field of view of the virtual object in response to an adjustment operation of the field of view of the virtual object through the operation control:
adjusting visibility of the scene auxiliary information, wherein the adjusted visibility of the scene auxiliary information is lower than visibility of the operation control; and
restoring the visibility of the scene auxiliary information when the adjustment operation of the field of view ends.

An embodiment of this application further provides an electronic device, including:
a memory, configured to store computer-executable instructions; and
a processor, configured to implement the method for displaying information in the virtual scene provided in the embodiments of this application when executing the computer-executable instructions stored in the memory.

An embodiment of this application further provides a non-transitory computer-readable storage medium, having computer-executable instructions stored therein, the computer-executable instructions, when executed by a processor, implementing the method for displaying information in the virtual scene provided in the embodiments of this application.

The embodiments of this application include the following beneficial effects:

When the embodiments of this application are applied, scene auxiliary information of a virtual scene and an operation control configured to control an action of a virtual object in the virtual scene are displayed. When an adjustment operation of a field of view is received, in the virtual scene, content in the field of view of the virtual object is adjusted. In addition, in a process of adjusting the content, visibility of the scene auxiliary information is adjusted, so that the visibility of the scene auxiliary information is lower than visibility of the operation control. The visibility of the scene auxiliary information is restored when the adjustment operation of the field of view ends. In this way, when the control operation is performed on the virtual scene, the visibility of the scene auxiliary information may be adjusted, so that the visibility of the scene auxiliary information is lower than the visibility of the operation control. Therefore, (1) complexity of information display can be reduced, and utilization of display resources is improved; (2) a user is enabled to focus more on the operation control and the virtual scene. This facilitates the user to quickly control the action of the virtual object based on the operation control, to improve human-computer interaction efficiency and utilization of hardware processing resources.

### BRIEF DESCRIPTION OF THE DRAWINGS

FIG. 1A is a schematic diagram of an application mode of a method for displaying information in a virtual scene according to an embodiment of this application.

FIG. 1B is a schematic diagram of an application mode of a method for displaying information in a virtual scene according to an embodiment of this application.

FIG. 2 is a schematic diagram of a structure of an electronic device 500 implementing a method for displaying information in a virtual scene according to an embodiment of this application.

FIG. 3 is a schematic diagram of a principle of a human-computer interaction engine installed in an apparatus for displaying information in a virtual scene according to an embodiment of this application.

FIG. 4 is a schematic flowchart of a method for displaying information in a virtual scene according to an embodiment of this application.

FIG. 5 is a schematic diagram of triggering an adjustment operation of a field of view according to an embodiment of this application.

FIG. 6 is a schematic diagram of triggering an adjustment operation of a field of view according to an embodiment of this application.

FIG. 7 is a schematic diagram of an interface of a virtual scene according to an embodiment of this application.

FIG. 8 is a schematic flowchart of a method for displaying information in a virtual scene according to an embodiment of this application.

FIG. 9 is a schematic diagram of hierarchical display of information according to an embodiment of this application.

FIG. 10 is a schematic flowchart of a method for displaying information in a virtual scene according to an embodiment of this application.

FIG. 11 is a hierarchical flowchart of information in a virtual scene according to an embodiment of this application.

FIG. 12 is a schematic flowchart of a screen swipe operation according to an embodiment of this application.

FIG. 13 is a schematic flowchart of adjusting opacity according to an embodiment of this application.

FIG. 14A is a schematic diagram of displaying a prompt information layer according to an embodiment of this application.

FIG. 14B is a schematic diagram of displaying an information display layer according to an embodiment of this application.

FIG. 14C is a schematic diagram of displaying a basic operation layer according to an embodiment of this application.

### DESCRIPTION OF EMBODIMENTS

To make objectives, technical solutions, and advantages of this application clearer, the following further describes this application in detail with accompanying drawings. The described embodiments are not to be construed as limitation on this application. All other embodiments obtained by a person of ordinary skill in the art based on the embodiments of this application without creative efforts shall fall within the protection scope of this application.

“Some embodiments” involved in the following description describes a subset of all possible embodiments. However, “some embodiments” may be same or different subsets of all the possible embodiments, and may be combined with each other when there is no conflict.

In the following description, the terms “first”, “second”, and “third” are merely intended to distinguish between similar objects and do not indicate a specific sequence of the objects. A specific order or sequence of the “first”, “second”, and “third” may be interchanged if permitted, so that the embodiments of this application described herein may be implemented in a sequence other than the sequence illustrated or described herein.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are further described in detail, terms involved in the embodiments of this application are described, and the following explanations are applicable to the terms involved in the embodiments of this application.

(1) A client is an application that runs in a terminal and that is configured to provide various services, such as a client supporting a virtual scene (such as a game scene).

(2) “In response to” is configured for representing a condition or a status on which an executed operation depends, and when a dependent condition or status is met, one or more executed operations may be in real time or may have a set delay. Unless otherwise specified, there is no restriction on an execution sequence of a plurality of executed operations.

(3) The virtual scene is a virtual scene displayed (or provided) when the application runs on the terminal. The virtual scene may be a simulated environment of the real world, may be a semi-simulated and semi-fictional virtual environment, or may be a purely fictional virtual environment. The virtual scene may be any one of a two-dimensional virtual scene, a 2.5-dimensional virtual scene, or a three-dimensional virtual scene.

For example, the virtual scene may include the sky, the land, and the ocean. The land may include environmental elements such as deserts and cities. A user may control a virtual object to perform an action in the virtual scene, and the action includes but is not limited to: any one of adjusting a body posture, crawling, walking, running, riding, jumping, driving, picking up, shooting, attacking, or throwing. The virtual scene may be a virtual scene displayed from a first-person perspective (for example, a virtual object in a game is played in a perspective of the user), may be a virtual scene displayed from a third-person perspective (for example, the game is played in a perspective of the user chasing the virtual object in the game), or may be a virtual scene displayed from an aerial view. The perspectives may be switched in any manner.

(4) Virtual objects are images of various people and objects that may be interacted with in the virtual scene, or movable objects in the virtual scene. The movable object may be a virtual character, a virtual animal, an animation character, or the like, for example, a person, an animal, a plant, an oil drum, a wall, or a stone displayed in the virtual scene. The virtual object may be a virtual avatar representing the user in the virtual scene. The virtual scene may include a plurality of virtual objects. Each virtual object has a shape and a volume of the virtual object in the virtual scene, and occupies a part of space in the virtual scene.

For example, the virtual object may be a user role controlled through operations on the client, may be artificial intelligence (AI) set in a fight in the virtual scene through training, or may be a non-player character (NPC) set in interaction in the virtual scene. A quantity of virtual objects participating in the interaction in the virtual scene may be preset, or may be dynamically determined based on a quantity of clients participating in the interaction.

(5) A massive multiplayer online role-playing game (MMORPG) is a type of online game, and is a role-playing game in which players need to play a fictional role and control behaviors and actions of the role.

(6) A first-person shooting game (FPS) is a shooting game based on a perspective of the player.

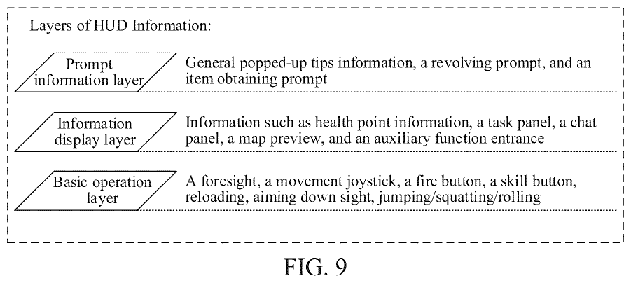

(7) Head-up display (HUD), also be referred to as a head-up display system, displays information (namely, HUD information, referring to FIG. 9 for detail) related to the virtual scene on an interface of the virtual scene, so that the player can perceive the most important and directly relevant content of the virtual scene at any time.

The embodiments of this application provide a method and apparatus for displaying information in a virtual scene, an electronic device, a non-transitory computer-readable storage medium, and a computer program product. This can reduce complexity of information display, and improve utilization of display resources and human-computer interaction efficiency.

For case of understanding the method for displaying the information in the virtual scene provided in the embodiments of this application, the following describes an exemplary embodiment scene of the method for displaying the information in the virtual scene provided in the embodiments of this application. The virtual scene of the method for displaying the information in the virtual scene provided in the embodiments of this application may be completely outputted based on a terminal device, or may be collaboratively outputted based on a terminal device and a server.

In some embodiments, the virtual scene may be an environment for game characters to interact, for example, may be an environment for game characters to fight. Actions of the game characters may be controlled for both parties to interact in the virtual scene, so that the user can obtain gaming experience during the game.

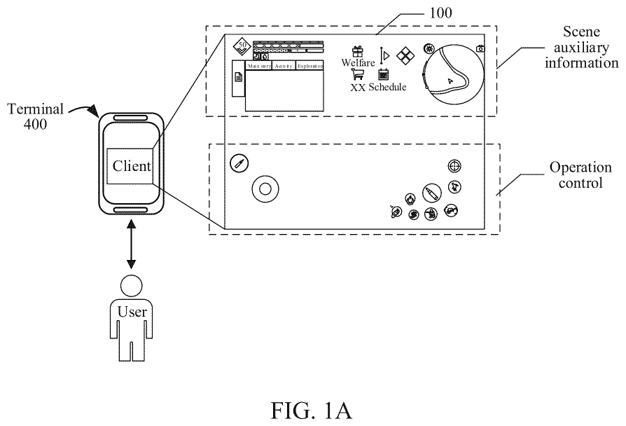

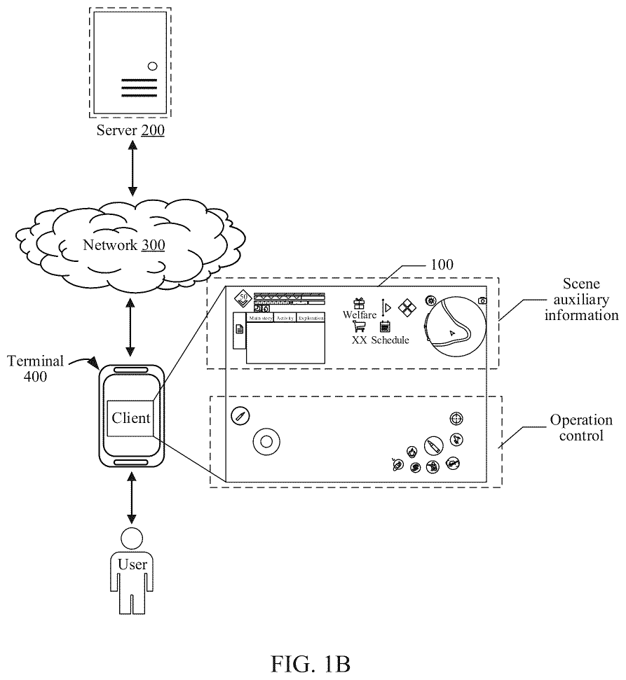

In an embodiment scene, refer to FIG. 1A. FIG. 1A is a schematic diagram of an application mode of a control method of a virtual object, and is applied to some application modes that completely depend on computing power of a terminal 400 to complete related data calculation of a virtual scene 100. For example, in a console game or an offline mode game, the terminal 400 such as a smart phone, a tablet, and a virtual reality/augmented reality device is used to complete an output of the virtual scene. When forming visual perception of the virtual scene 100, the terminal 400 calculates data needed for display by using graphics computing hardware, completes loading, parsing, and rendering of display data, and outputs a video frame that can form the visual perception of the virtual scene by using graphics output hardware, for example, a two-dimensional video frame that is displayed on a display screen of the smartphone, or a video frame for implementing a three-dimensional display effect that is displayed on lenses of augmented reality/virtual reality glasses. In addition, to enrich a perception effect, the device may also use different hardware to form one or more of auditory perception, tactile perception, motion perception, and taste perception.

For example, the terminal 400 runs a client (such as a game client in the single player version), and outputs the virtual scene based on scene data of the virtual scene in a running process of the client. The virtual scene is an environment for interaction of the game characters, for example, may be plains, streets, and valleys for the game characters to fight. After the virtual scene is outputted, scene auxiliary information of the virtual scene is displayed, and an operation control of the virtual scene is displayed. The operation control is configured to control an action of the virtual object in the virtual scene. The user may trigger an adjustment operation of a field of view for the virtual scene. The terminal 400 adjusts, in response to the adjustment operation of the field of view, content in the field of view of the virtual object in the virtual scene; and adjusts visibility of the scene auxiliary information in a process of adjusting the content, adjusted visibility of the scene auxiliary information being lower than visibility of the operation control. The visibility of the scene auxiliary information is restored when the adjustment operation of the field of view ends.

In another embodiment scene, referring to FIG. 1B, FIG. 1B is a schematic diagram of an application mode of a control method of a virtual object, is applied to a terminal 400 and a server 200, and is generally applied to an application mode in which completing computing of the virtual scene and outputting the virtual scene in the terminal 400 depend on computing power of the server 200. That visual perception of a virtual scene 100 is formed is used as an example. The server 200 calculates related display data of the virtual scene, and sends the display data to the terminal 400. The terminal 400 depends on graphics computing hardware to complete loading, parsing, and rendering of calculation of the display data, and depends on graphics output hardware to output the virtual scene to form the visual perception, for example, may display a two-dimensional video frame on a display screen of a smartphone, or display a video frame for implementing a three-dimensional display effect on lenses of augmented reality/virtual reality glasses. For perception in a form of the virtual scene, related hardware of the terminal may be used for output, for example, microphone output is used to form auditory perception, and vibrator output is used to form tactile perception.

For example, the terminal 400 runs a client (such as a game client in an online version), obtains scene data of the virtual scene by connecting to a game server (namely, the server 200), and outputs the virtual scene based on the obtained scene data, to interact with other users in the virtual scene in a game. After outputting the virtual scene, the terminal 400 displays scene auxiliary information of the virtual scene, and displays an operation control of the virtual scene. The operation control is configured to control an action of the virtual object in the virtual scene. The user may trigger an adjustment operation of a field of view for the virtual scene. The terminal 400 adjusts, in response to the adjustment operation of the field of view, content in the field of view of the virtual object in the virtual scene; and adjusts visibility of the scene auxiliary information in a process of adjusting the content, adjusted visibility of the scene auxiliary information being lower than visibility of the operation control. The visibility of the scene auxiliary information is restored when the adjustment operation of the field of view ends.

In some embodiments, the terminal or the server may implement the method for displaying the information in the virtual scene provided in the embodiments of this application by running a computer program. For example, the computer program may be an original program or a software module in an operating system, or may be a native application (APP), to be specific, a program that needs to be installed in the operating system to run, or may be a mini program, to be specific, a program that only needs to be downloaded to a browser environment to run, or may be a mini program that can be embedded in any APP. In conclusion, the computer program may be any form of an application, a module, or a plug-in.

The embodiments of this application may be implemented by using a cloud technology. The cloud technology is a hosting technology that unifies a series of resources such as hardware, software, and a network in a wide area network or a local area network, to implement data computing, storage, processing, and sharing. Cloud technology is a general term for a network technology, an information technology, an integration technology, a management platform technology, an application technology, and the like that are applied based on a cloud computing business model. The technologies can form a resource pool to be flexibly used on demand. A cloud computing technology is becoming an important support. A background service of a technical network system needs a large quantity of computing and storage resources.

For example, the server (such as the server 200) may be an independent physical server, or a server cluster or a distributed system including a plurality of physical servers, or may alternatively be a cloud server that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal (such as the terminal 400) may be a smartphone, a tablet computer, a laptop computer, a desktop computer, an intelligent voice interaction device (such as a smart speaker), a smart appliance (such as a smart television), a smart watch, and a vehicle terminal, but this is not limited thereto. The terminal and the server may be connected directly or indirectly in a wired or wireless communication protocol. This is not limited in the embodiments of this application.

In some embodiments, a plurality of servers may form a blockchain, and the server is a node on the blockchain. Information connection may exist between nodes of the blockchain, and information transmission may be performed between the nodes through the information connection. Data (such as the scene data of the virtual scene) related to the method for displaying information in the virtual scene provided in the embodiments of this application may be stored in the blockchain.

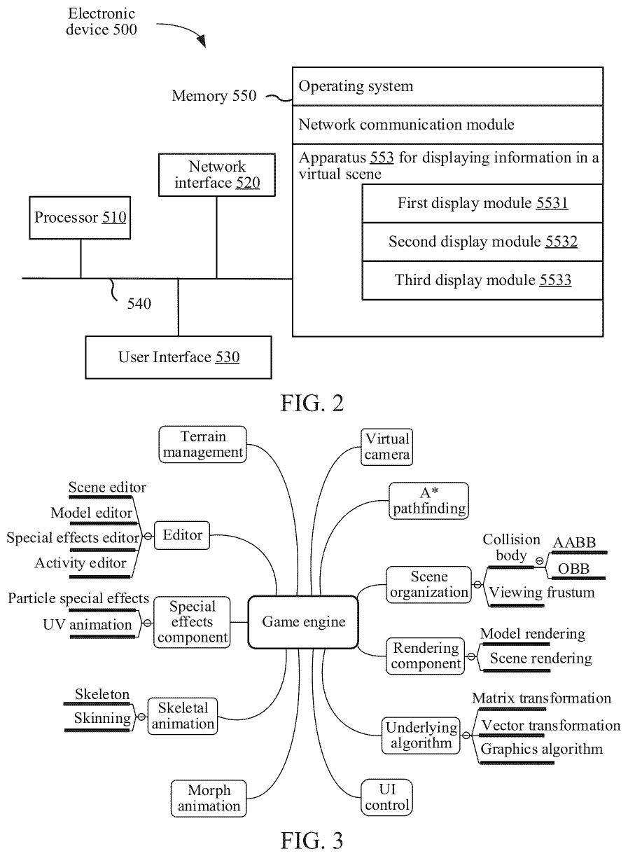

The following describes an electronic device that implements a method for displaying information in a virtual scene provided in the embodiments of this application. Referring to FIG. 2, FIG. 2 is a schematic diagram of a structure of an electronic device 500 of a method for displaying information in a virtual scene according to an embodiment of this application. That the electronic device 500 is the terminal shown in FIG. 1 is used as an example. The electronic device 500 of the method for displaying the information in the virtual scene provided in the embodiments of this application includes at least one processor 510, a memory 550, at least one network interface 520, and a user interface 530. All components in the electronic device 500 are coupled together by using a bus system 540. The bus system 540 is configured to implement connection and communication between the components. In addition to a data bus, the bus system 540 further includes a power bus, a control bus, and a status signal bus. However, for ease of clear description, all types of buses are marked as the bus system 540 in FIG. 2.

In some embodiments, an apparatus for displaying the information in the virtual scene provided in the embodiments of this application may be implemented in a software manner. FIG. 2 shows an information display apparatus 553 of the virtual scene that is stored in a memory 550. The information display apparatus 553 may be software in the form of a program, a plug-in, or the like, including the following software modules: a first display module 5531, a second display module 5532, and a third display module 5533. These modules are logical, so that the modules may be combined or further split based on functions implemented. The functions of the modules are explained in the following.

Referring to FIG. 3, FIG. 3 is a schematic diagram of a principle of a human-computer interaction engine installed in an apparatus for displaying information in a virtual scene according to an embodiment of this application. A method for displaying information in a virtual scene provided in the embodiments of this application may be implemented by each module in the apparatus for displaying the information in the virtual scene shown in FIG. 2 by invoking a related module, component, or plug-in of a game engine shown in FIG. 3. The following is an exemplary description of the module, the component, or the plug-in included in the game engine shown in FIG. 3.

As shown in FIG. 3, the game engine includes the following parts: (1) Virtual camera: A virtual camera is a necessary component for a game scene image, and is configured for displaying the game scene image. One game scene corresponds to at least one virtual camera. Based on an actual need, two or more virtual cameras may be used as windows for game rendering, to capture and display screen content of a game world for a user. A parameter of the virtual camera may be set to adjust a perspective of the user of viewing the game world, such as a first-person perspective or a third-person perspective.

(2) Scene organization: Scene organization is configured for game scene management, such as collision detection and visibility culling. A collision body may be used to implement the collision detection. Based on an actual need, an axis-aligned bounding box (AABB) or an oriented bounding box (OBB) may be used to implement collision body. The visibility culling may be implemented based on a viewing frustum. The viewing frustum is a three-dimensional frame generated based on the virtual camera, and is configured to cut objects outside a visible range of the camera. Objects inside the viewing frustum are projected to a viewing plane, and objects outside the viewing frustum are discarded and not processed.

(3) Terrain management: Terrain management is a component for managing terrain in a game scene, and is configured to create and edit game terrain, such as creating mountains, canyons, caves, and other terrain in the game scene.

(4) Editor: An editor is an auxiliary tool in game design, including:
a scene editor, configured to edit content of the game scene, for example, change terrain and customize vegetation distribution and lighting layout;
a model editor, configured to produce and edit a model (a character model in the game scene) in the game;
a special effects editor, configured to edit special effects in the game image; and
an action editor, configured to define and edit actions of characters in the game image.

(5) Special effects component: A special effects component is configured to produce and edit game special effects in the game image, and in an actual application, particle special effects and a texture UV animation may be used to implement the special effects. The particle special effect means that countless individual is combined to form a fixed shape, and overall or individual movement of the particles is controlled by using a controller or a script to simulate effects such as water, fire, fog, and air in real life. The UV animation is a texture animation implemented by dynamically modifying UV coordinates of stickers.

(6) Skeletal animation: A skeletal animation is an animation implemented by using built-in skeleton to drive objects to move. The skeletal animation may be understood as the following two concepts.

Skeleton: A skeleton is an abstract concept configured to control skinning, for example, a human skeleton that controls a skin.

Skinning: The skin is controlled by the skeleton, and displays outside factors, for example, a skin of a human body is affected by the skeleton.

(7) Morph animation: A morph animation is a deformation animation, and is an animation implemented by adjusting a vertex of a basic model.

(8) UI control: A UI control is a control configured to implement game image display.

(9) Underlying algorithm: An underlying algorithm is an algorithm that needs to be invoked for implementation of functions in the game engine, such as a graphical algorithm needed to implement the scene organization, and matrix transformation and vector transformation needed to implement the skeletal animation.

(10) Rendering component: A rendering component is a necessary component for presenting a game image effect. The rendering component converts a scene described by three-dimensional vectors to a scene described by two-dimensional pixels, including model rendering and scene rendering.

(11) A* pathfinding: A* pathfinding is an algorithm for seeking the shortest path used to perform path planning, pathfinding, and graph traversal in the game design.

For example, the UI control of the game engine shown in FIG. 3 may be invoked to implement interaction between the user and the game. The morph animation section of the game engine is invoked to produce a two-dimensional or three-dimensional model. In addition, after the model is produced, material stickers are assigned to the model based on different surfaces by using the skeleton animation section. This is equivalent to overlaying a skin for the skeleton. Finally, the rendering component is used to calculate all effects such as the model, the animation, lighting, and the special effects in real time and display the effects on a human-computer interaction interface. Specifically, after rendering virtual scene data by invoking the rendering component of the game engine shown in FIG. 3, the first display module 5531 may output the virtual scene, display scene auxiliary information of the virtual scene, and display an operation control of the virtual scene, the operation control being configured to control an action of a virtual object in the virtual scene. The second display module 5532 may receive an adjustment operation of a field of view by invoking the UI control of the game engine shown in FIG. 3; then adjust, in response to the adjustment operation of the field of view, content in the field of view of the virtual object in the virtual scene; and adjust visibility of the scene auxiliary information in a process of adjusting the content, adjusted visibility of the scene auxiliary information being lower than visibility of the operation control. The third display module 5533 may invoke the UI control of the game engine shown in FIG. 3 to detect whether the adjustment operation of the field of view ends, and restore the visibility of the scene auxiliary information when the adjustment operation of the field of view ends.

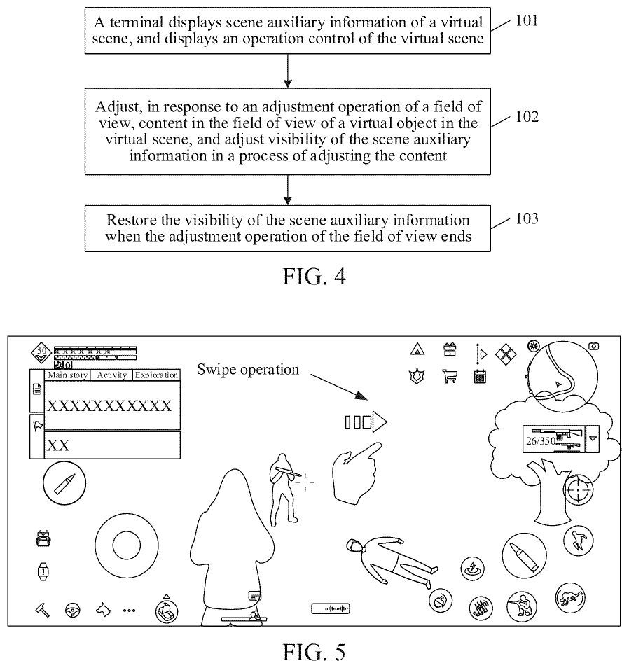

The following describes a method for displaying information in a virtual scene provided in the embodiments of this application. In some embodiments, the method for displaying the information in the virtual scene provided in the embodiments of this application may be implemented by various electronic devices, for example, may be implemented by a terminal alone, or may be implemented by a server alone, or may be implemented by the terminal and the server collaboratively. That the information display method is implemented by the terminal is used as an example. Referring to FIG. 4, FIG. 4 is a schematic flowchart of a method for displaying information in a virtual scene according to an embodiment of this application. The method for displaying the information in the virtual scene provided in the embodiments of this application includes the following operations:

Operation 101: The terminal displays scene auxiliary information of the virtual scene, and displays an operation control of the virtual scene,
the operation control being configured to control an action of a virtual object in the virtual scene.

In an actual implementation, the terminal may run a client (for example, a game client) that supports the virtual scene. The terminal outputs the virtual scene (for example, a shooting game scene) in a running process of the client, to be specific, the terminal may display an interface of the virtual scene, and display, in the interface of the virtual scene, the scene auxiliary information of the virtual scene and the operation control configured to control the action of the virtual object in the virtual scene.

In some embodiments, the terminal may display the scene auxiliary information of the virtual scene, and display the operation control of the virtual scene in the following manner: displaying the scene auxiliary information through a first displaying layer of a view layer, and displaying the operation control of the virtual scene through a second displaying layer that is independent of the first displaying layer, the scene auxiliary information including at least one of the following: prompt information configured for prompting an event or a status in the virtual scene, or entrance information of an auxiliary function of the virtual scene.

In an actual application, the scene auxiliary information may include the prompt information configured for prompting the event or the status in the virtual scene, such as an obtaining prompt of a virtual item or a usage prompt of the virtual item. The scene auxiliary information may alternatively include the entrance information of the auxiliary function of the virtual scene, such as a chat panel, a task panel, attribute (such as a health point and an attack point) information, and a map preview. The operation control is configured to control the action of the virtual object in the virtual scene, such as a jump control, a movement control, and a shooting control. In this way, different display layers may be used to respectively display the scene auxiliary information and the operation control. Therefore, visibility of the scene auxiliary information may be easily adjusted subsequently, to improve processing efficiency.

In some embodiments, the terminal may display the scene auxiliary information of the virtual scene and the operation control in the following manner: displaying the scene auxiliary information of the virtual scene at first visibility, and displaying the operation control at second visibility. In an actual application, the first visibility and the second visibility may be the same, or the first visibility may be lower than the second visibility.

Operation 102: Adjust, in response to an adjustment operation of a field of view, content in the field of view of the virtual object in the virtual scene, and adjust the visibility of the scene auxiliary information in a process of adjusting the content
adjusted visibility of the scene auxiliary information being lower than visibility of the operation control.

In some embodiments, a user may perform control operation in the virtual scene, for example, control the virtual object to move, control the virtual object to turn, and adjust the field of view in which a virtual camera photographs the virtual scene. In this embodiment of this application, when performing the adjustment operation (for example, adjusting the field of view to find a target of the virtual scene, or adjusting the field of view to move in different directions) of the field of view, the terminal adjusts, in response to the adjustment operation, the field of view of the virtual scene photographed by the virtual camera (that is, taking the virtual object as a perspective), to adjust content in the field of view of the virtual object. In addition, in a process of adjusting the content, the visibility of the scene auxiliary information is adjusted, so that the visibility of the scene auxiliary information is lower than the visibility of the operation control. This facilitates the user to focus on the operation control and the virtual scene faster, reduces complexity of information display, facilitates the user to check the virtual scene, facilitates the user to quickly control the action of the virtual object based on the operation control, and improves human-computer interaction efficiency.

In some embodiments, the terminal may receive the adjustment operation of the field of view in the following manner: receiving a swipe operation performed on an interface of the virtual scene, the swipe operation being configured for adjusting the content in the field of view of the virtual object by swiping content of the virtual scene displayed on the interface; and determining the swipe operation as the adjustment operation of the field of view.

In an actual implementation, the adjustment operation of the field of view may be implemented by performing the swipe operation on the interface of the virtual scene. The swipe operation is configured for swiping the content of the virtual scene displayed on the interface of the virtual scene, to adjust the content in the field of view of the virtual object. When the terminal receives the swipe operation performed on the interface of the virtual scene, the terminal determines the swipe operation as the adjustment operation of the field of view, that is, determines that the adjustment operation of the field of view is received. For example, referring to FIG. 5, FIG. 5 is a schematic diagram of triggering an adjustment operation of a field of view according to an embodiment of this application. The adjustment operation of the field of view is implemented by swiping an interface of a virtual scene, to be specific, a swipe operation is performed on the interface of the virtual scene, to implement the adjustment operation of the field of view. In this way, the interface of the virtual scene may be swiped to trigger the adjustment operation of the field of view. The operation is simple. Therefore, this reduces complexity of human-computer interaction for triggering the adjustment operation of the field of view, and improves human-computer interaction efficiency.

In some embodiments, the terminal may receive the adjustment operation of the field of view in the following manner: displaying a turning control configured to control an orientation of a virtual object; and receiving a turning operation for the virtual object and triggered based on the turning control, and determining the turning operation as the adjustment operation of the field of view.

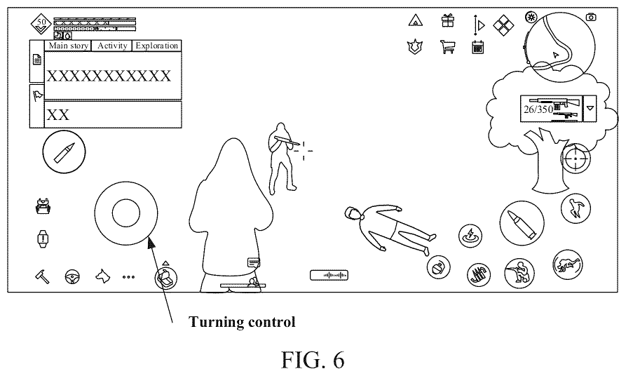

In an actual implementation, the turning operation may be used to implement the adjustment operation of the field of view. Specifically, the turning control configured to control the orientation of the virtual object may be displayed, for example, the turning control is displayed on the interface of the virtual scene, and a user may control the orientation of the virtual object to turn by using the turning control. When the turning operation for the virtual object triggered based on the turning control is received, the turning operation is determined as the adjustment operation of the field of view, that is, it is determined that the adjustment operation of the field of view is received. For example, referring to FIG. 6, FIG. 6 is a schematic diagram of triggering an adjustment operation of a field of view according to an embodiment of this application. A turning control, that is, a turning wheel, is displayed on an interface of a virtual scene. The turning control may be used to trigger a turning operation for a virtual object, to implement the adjustment operation of the field of view. In this way, the turning control is provided to provide a corresponding triggering control for triggering the adjustment operation of the field of view, so that triggering of the adjustment operation of the field of view becomes simple, and human-computer interaction efficiency is improved.

In some embodiments, preset transparency is used to display the operation control, and a terminal may adjust visibility of scene auxiliary information in the following manner: adjusting transparency of the scene auxiliary information to target transparency higher than the preset transparency, to adjust the visibility of the scene auxiliary information.

In an actual implementation, the preset transparency may be used to display the operation control. When adjusting the visibility of the scene auxiliary information, the terminal may adjust the transparency of the scene auxiliary information, specifically, may adjust the transparency of the scene auxiliary information to the target transparency higher than the preset transparency. The target transparency may be full transparency, to be specific, no scene auxiliary information is displayed at all. The target transparency may further be higher than the preset transparency but not the full transparency, to differently display the scene auxiliary information and the operation control, so that the visibility of the scene auxiliary information is lower than the visibility of the operation control. In this way, the transparency of the scene auxiliary information is adjusted to implement adjustment of the visibility of the scene auxiliary information. This can reduce complexity of information display, facilitate a user to quickly control an action of the virtual object based on the operation control, and improve human-computer interaction efficiency.

In some embodiments, the scene auxiliary information has a display state and a hidden state. The display state is configured to indicate to display the scene auxiliary information, and the hidden state is configured to indicate to hide the scene auxiliary information. The terminal may display the scene auxiliary information of the virtual scene in the following manner: controlling the scene auxiliary information of the virtual scene to be in the display state. Correspondingly, the terminal may adjust the visibility of the scene auxiliary information in the following manner: controlling the scene auxiliary information of the virtual scene to be adjusted from the display state to the hidden state.

In an actual implementation, a status of the scene auxiliary information may further be set, including the display state and the hidden state. When displaying the scene auxiliary information of the virtual scene, the terminal may control the scene auxiliary information to be in the display state. When adjusting the visibility of the scene auxiliary information, the terminal may control the scene auxiliary information to be adjusted from the display state to the hidden state. In this way, that the status of the scene auxiliary information is controlled to be switched from the display state to the hidden state is equivalent to that the scene auxiliary information is canceled from being displayed. Therefore, this may further reduce the complexity of the information display, facilitates the user to quickly control the action of the virtual object based on the operation control, and improves the human-computer interaction efficiency.

In some embodiments, the scene auxiliary information includes a plurality of pieces of auxiliary information, and the terminal may adjust the visibility of the scene auxiliary information in the following manner: obtaining scene data of the virtual scene and interaction data of the virtual object; invoking a first neural network model based on the scene data and the interaction data, to predict to-be-adjusted auxiliary information of the plurality of pieces of auxiliary information, to obtain a prediction result; and adjusting visibility of auxiliary information indicated by the prediction result.

In an actual implementation, the scene auxiliary information includes the plurality of pieces of auxiliary information. When the visibility of the scene auxiliary information is adjusted, the visibility of some of the plurality of pieces of auxiliary information may be adjusted. In some embodiments, a neural network model may be used to predict the to-be-adjusted auxiliary information, that is, the first neural network model configured for predicting the to-be-adjusted auxiliary information is obtained. The first neural network model is completed through training. Specifically, a scene data sample of the virtual scene and an interaction data sample of the virtual object may be used as training samples, and the adjusted auxiliary information may be used as a label to train the first neural network model, to obtain a trained first neural network model. Then, when the to-be-adjusted auxiliary information is predicted, the scene data of the virtual scene and the interaction data of the virtual object are obtained, and the first neural network model is invoked based on the scene data and the interaction data, to predict the to-be-adjusted auxiliary information of the plurality of pieces of auxiliary information, to obtain a prediction result. Therefore, the visibility of the auxiliary information indicated by the prediction result is adjusted. In this way, visibility of some of the plurality of pieces of auxiliary information is adjusted. In addition, the neural network model is used to predict the to-be-adjusted auxiliary information, so that visibility of some of the auxiliary information may be automatically adjusted for the user based on the scene data and the interaction data of the user in the virtual scene. Therefore, this improves utilization of hardware resources and intelligence of auxiliary information display, and better meets user requirements.

In some embodiments, the scene auxiliary information includes the plurality of pieces of auxiliary information, and the terminal may adjust the visibility of the scene auxiliary information in the following manner: determining a similar historical virtual scene of the virtual scene for the virtual object, a similarity between the similar historical virtual scene and the virtual scene being greater than a similarity threshold; obtaining usage data for the scene auxiliary information in a process of adjusting content in the similar historical virtual scene; and determining to-be-adjusted target auxiliary information from the plurality of pieces of auxiliary information based on the usage data, and adjusting visibility of the target auxiliary information.

In an actual implementation, the scene auxiliary information includes the plurality of pieces of auxiliary information. When the visibility of the scene auxiliary information is adjusted, the visibility of some of the plurality of pieces of auxiliary information may be adjusted. In some embodiments, to-be-adjusted target auxiliary information may further be determined in a manner of statistical historical data. Specifically, the similar historical virtual scene of the virtual scene for the virtual object is determined first, the similarity between the similar historical virtual scene and the virtual scene being greater than the similarity threshold. Then the usage data (that is, historical usage data, and the historical usage data may be of a current user or of a plurality of selected target users) for the scene auxiliary information in the process of adjusting content in the similar historical virtual scene is obtained. The usage data may be a usage frequency, a check frequency, and the like of each auxiliary information. Therefore, the to-be-adjusted target auxiliary information is determined from the plurality of pieces of auxiliary information based on the usage data, for example, the auxiliary information whose usage frequency is lower than the frequency threshold is used as the target auxiliary information, to adjust the visibility of the target auxiliary information. In this way, the visibility of some of the plurality of pieces of auxiliary information is adjusted. In addition, the visibility of some of the plurality of pieces of auxiliary information is automatically adjusted for the user based on the usage data in the similar historical virtual scene. Therefore, this improves the utilization of the hardware resources and the intelligence of the auxiliary information display, and better meets the user requirements.

In an actual implementation, there may be a plurality of operation controls. When adjusting the visibility of the scene auxiliary information, the terminal may further adjust visibility of some of the plurality of operation controls. In some embodiments, there are the plurality of operation controls, and the terminal may adjust the visibility of some of the plurality of operation controls in the following manner: obtaining the interaction data of the virtual object and the scene data of the virtual scene; invoking a second neural network model based on the interaction data and the scene data, to predict a to-be-used operation control of the plurality of operation controls, to obtain the prediction result; and when the prediction result indicates that the to-be-used operation control is a first operation control, adjusting visibility of a second operation control, adjusted visibility of the second operation control being lower than visibility of the first operation control, and the second operation control being an operation control other than the first operation control of the plurality of operation controls.

In an actual implementation, the neural network model may be used to predict the to-be-used operation control, that is, the second neural network model configured for predicting the to-be-used operation control is obtained. The second neural network model is completed through training. Specifically, the scene data sample of the virtual scene and the interaction data sample of the virtual object may be used as the training samples, and the corresponding to-be-used operation control may be used as the label to train the second neural network model, to obtain a trained second neural network model. Then, when the to-be-used operation control is predicted, the scene data of the virtual scene and the interaction data of the virtual object are obtained, and the second neural network model is invoked based on the scene data and the interaction data, to predict the to-be-used operation control of the plurality of operation controls, to obtain the prediction result. When the prediction result indicates that the to-be-used operation control is the first operation control, the visibility of the second operation control is adjusted, so that the visibility of the second operation control is lower than the visibility of the first operation control, and the second operation control is the operation control other than the first operation control of the plurality of operation controls. In this way, that the visibility of some of the plurality of operation controls is adjusted is implemented. This can further reduce the complexity of the information display, facilitate the user to quickly control the action of the virtual object based on the needed operation control, and improve the human-computer interaction efficiency. In addition, the neural network model may be used, based on the scene data and the interaction data of the users in the virtual scene, to automatically determine the visibility that needs to be adjusted of the operation control for the users. Therefore, this improves the utilization of the hardware resources and the intelligence of the auxiliary information display, and better meets the user requirements.

In some embodiments, there are the plurality of operation controls, and the terminal may adjust the visibility of some of the plurality of operation controls in the following manner: determining the similar historical virtual scene of the virtual scene for the virtual object, the similarity between the similar historical virtual scene and the virtual scene being greater than the similarity threshold; determining the first operation control whose usage frequency is lower than the frequency threshold in the process of adjusting the content in the similar historical virtual scene; and adjusting the visibility of the first operation control, the adjusted visibility of the first operation control being lower than the visibility of a second operation control, and the second operation control is the operation control other than the first operation control of the plurality of operation controls.

In an actual implementation, a to-be-adjusted target operation control may further be determined in a manner of the statistical historical data. Specifically, the similar historical virtual scene of the virtual scene for the virtual object is determined first, the similarity between the similar historical virtual scene and the virtual scene being greater than the similarity threshold. Then the first operation control whose usage frequency is lower than the frequency threshold is obtained in the process of adjusting content in the similar historical virtual scene, to adjust the visibility of the first operation control, so that the visibility of the first operation control is lower than the visibility of the second operation control. The second operation control is the operation control other than the first operation control in the plurality of operation controls. In this way, that the visibility of some of the plurality of operation controls is adjusted is implemented. This can further reduce the complexity of the information display, facilitate the user to quickly control the action of the virtual object based on the needed operation control, and improve the human-computer interaction efficiency. In addition, the visibility that needs to be adjusted of the operation control is automatically determined for the user based on the usage frequency for the operation control of the user in the similar historical virtual scene. Therefore, this improves the utilization of the hardware resources and the intelligence of the information display, and better meets the user requirements.

In some embodiments, the terminal may display an information intelligent display switch of the virtual scene, and in response to an on instruction for the information intelligent display switch, control an information display mode of the virtual scene to be an information intelligent display mode. Correspondingly, the terminal may adjust the visibility of the scene auxiliary information in the following manner: when the information display mode of the virtual scene is the information intelligent display mode, adjusting the visibility of the scene auxiliary information in the process of adjusting the content.

In an actual implementation, the information intelligent display switch of the virtual scene may further be configured. When the information display mode of the virtual scene is needed to be controlled to be the information intelligent display mode, the information intelligent display switch is controlled to an on state. Specifically, the terminal may display the information intelligent display switch of the virtual scene. When receiving the on instruction for the information intelligent display switch, the terminal controls the information display mode of the virtual scene to be the information intelligent display mode. In this case, in the process of adjusting the content, the visibility of the scene auxiliary information is adjusted. In this way, the information intelligent display switch is provided to facilitate the user to turn the information intelligent display mode on or off as needed. This provides more choices for the users, and improves virtual scene experience of the user.

In some embodiments, the scene auxiliary information includes the plurality of pieces of auxiliary information. The terminal may display a selection control of each auxiliary information, and in response to a selection operation for the target auxiliary information triggered based on the selection control, determine the target auxiliary information as the scene auxiliary information displayed in the process of adjusting the content. Correspondingly, the terminal may adjust the visibility of the scene auxiliary information in the following manner: adjusting the visibility of the auxiliary information other than the target auxiliary information of the plurality of pieces of auxiliary information.

In an actual implementation, a personalization setting function for the auxiliary information to be displayed in the process of adjusting the content may further be provided. In other words, the terminal displays the selection control of each auxiliary information. After the target auxiliary information is selected based on the selection control, the target auxiliary information is determined as the scene auxiliary information displayed in the process of adjusting the content. In this way, when adjusting the visibility of the scene auxiliary information, the terminal adjusts the visibility of the auxiliary information other than the target auxiliary information of the plurality of pieces of auxiliary information. In addition, the selection control of each auxiliary information is provided for the user to set target auxiliary information whose visibility needs to be adjusted. This provides more control over the information display for the user, and improves the virtual scene experience of the user.

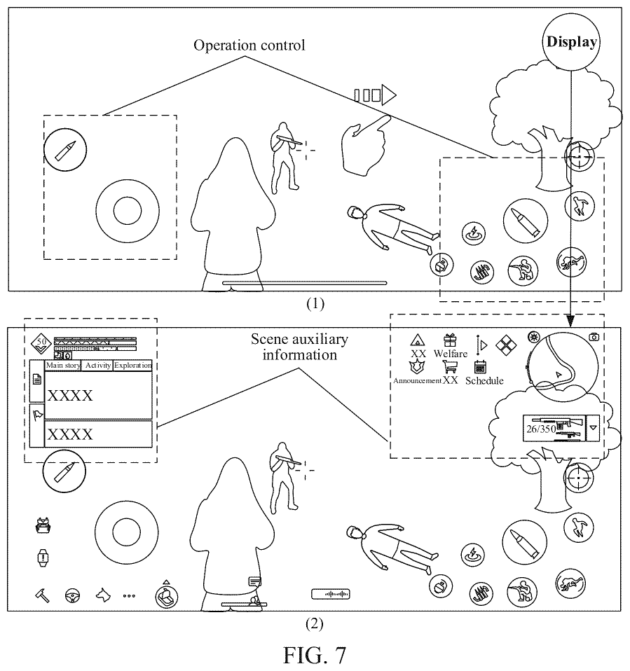

In some embodiments, after adjusting the visibility of the scene auxiliary information, the terminal may further display a display function option for the scene auxiliary information; and when receiving a trigger operation for the display function option, restore the visibility of the scene auxiliary information. For example, referring to FIG. 7, FIG. 7 is a schematic diagram of an interface of a virtual scene according to an embodiment of this application. In a process of adjusting content, visibility of scene auxiliary information is adjusted, so that the visibility of the scene auxiliary information is lower than visibility of an operation control. To be specific, the scene auxiliary information is canceled from being displayed on an interface of the virtual scene, and only the operation control is displayed. As shown in (1) of FIG. 7, a display function option “display” for the scene auxiliary information is also displayed. In response to a trigger operation for the display function option “display”, the visibility of the scene auxiliary information is restored, that is, the scene auxiliary information is displayed, as shown in (2) of FIG. 7. In this way, through the display function option of the scene auxiliary information, the visibility of the scene auxiliary information may be restored as needed at any time. This improves control of a user over information display in the virtual scene, and improves of the virtual scene experience of the user.

Operation 103: Restore the visibility of the scene auxiliary information when an adjustment operation of a field of view ends.

In some embodiments, the scene auxiliary information includes auxiliary information of a prompt type and auxiliary information of a non-prompt type. The terminal may display the scene auxiliary information of the virtual scene in the following manner: displaying the auxiliary information of the prompt type and the auxiliary information of the non-prompt type. Correspondingly, the terminal may restore the visibility of the scene auxiliary information in the following manner: restoring visibility of the auxiliary information of the non-prompt type.

In an actual implementation, the auxiliary information of the prompt type may be time-sensitive. Therefore, when the visibility of the scene auxiliary information is restored, a prompt before adjusting the visibility of the scene auxiliary information may be interrupted, that is, only the visibility of the auxiliary information of the non-prompt type is restored, and the auxiliary information of the prompt type is canceled from being displayed. The auxiliary information of the prompt type is prompt information configured for prompting an event or a status in the virtual scene, and auxiliary information of the non-prompt type is entrance information of an auxiliary function of the virtual scene. In this way, the visibility of the scene auxiliary information may be restored based on types of the scene auxiliary information, so that when the visibility of the scene auxiliary information is restored, the visibility of the scene auxiliary information can be restored appropriately and efficiently.

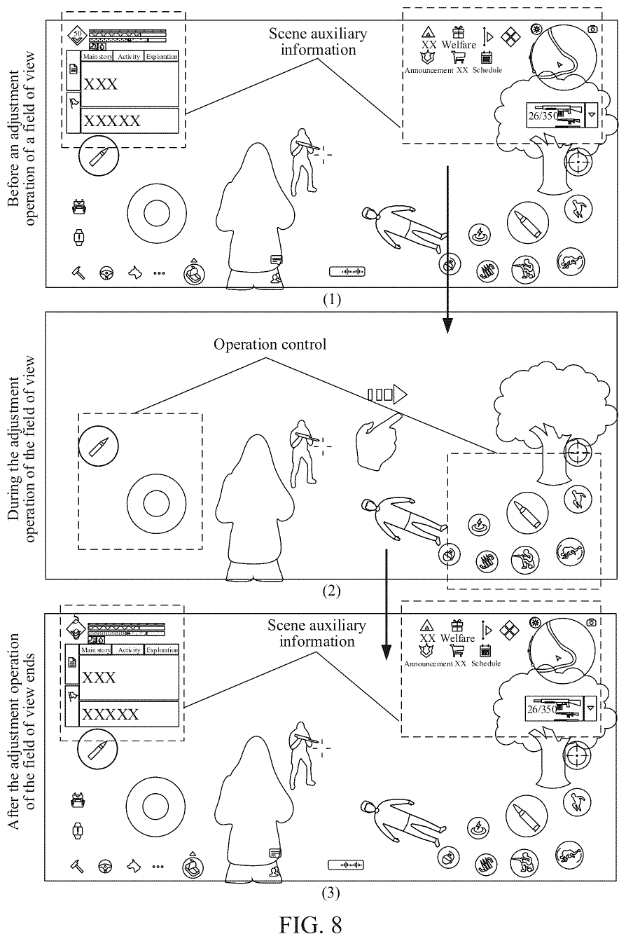

For example, referring to FIG. 8, FIG. 8 is a schematic flowchart of a method for displaying information in a virtual scene according to an embodiment of this application. As shown in FIG. 8 (1), in an interface of the virtual scene, scene auxiliary information and an operation control of the virtual scene is displayed. When a swipe operation executed in an interface of the virtual scene is received. In response to the swipe operation, content in a field of view of a virtual object in the virtual scene is adjusted. In addition, in a process of adjusting the content, visibility of the scene auxiliary information is adjusted, so that the visibility of the scene auxiliary information is lower than visibility of the operation control, that is, the scene auxiliary information is canceled from being displayed, and as shown in FIG. 8 (2), only the operation control is displayed. In response to an end of an adjustment operation of the field of view, the visibility of the scene auxiliary information is restored, that is, the scene auxiliary information is displayed again, as shown in FIG. 8 (3).

The embodiments of this application is applied. The scene auxiliary information of the virtual scene and the operation control configured to control an action of the virtual object in the virtual scene are displayed. When the adjustment operation of the field of view is received, in the virtual scene, the content in the field of view of the virtual object is adjusted. In addition, in the process of adjusting the content, the visibility of the scene auxiliary information is adjusted, so that the visibility of the scene auxiliary information is lower than the visibility of the operation control. The visibility of the scene auxiliary information is restored when the adjustment operation of the field of view ends. In this way, when the control operation is performed on the virtual scene, the visibility of the scene auxiliary information may be adjusted, so that the visibility of the scene auxiliary information is lower than the visibility of the operation control. Therefore, (1) complexity of information display can be reduced, and utilization of display resources is improved; (2) a user is enabled to focus more on the operation control and the virtual scene. This facilitates the user to quickly control the action of the virtual object based on the operation control, to improve human-computer interaction efficiency and utilization of hardware processing resources.

In the following, that the virtual scene is a game scene, and the screen swipe operation (that is, the swipe operation performed on a device screen) is used to trigger the adjustment operation of the field of view (to adjust the adjustment operation of the field of view of the virtual object to find a game object) are used as examples to describe an exemplary application of the embodiments of this application in a practical application scenario. In a game context (for example, an MMORPG+FPS type game), a main game interface is populated with HUD information such as various function entrances, controls, and cues, and the amount of information is large. In addition, game operations tend to be demanding on operational accuracy of players, for example, a shooting operation in the game needs the players to quickly focus on a shooting target, and excessive HUD information may interfere a focus of the target of the players.

Based on this, the embodiments of this application provide the method for displaying the information in the virtual scene, the HUD information (including the scene auxiliary information and operation control) of the virtual scene is displayed on a basic operation layer (for displaying the operation control) and an information display layer (for displaying the scene auxiliary information) respectively. When the game target is found by swiping the screen, the visibility of the scene auxiliary information is adjusted by reducing user interface (UI) opacity of the information display layer, information interference of HUD is reduced, and the players are allowed to focus on the game target faster in compact HUD. In addition, the basic operation layer UI is preserved. This satisfies a need of the players to quickly control the action (such as shooting) of the virtual object. After the swipe operation ends, visibility of the information display layer UI is restored again. In this way, a hierarchical processing of the HUD information reduces, based on that the basic operation control is preserved, interference of displayed UI information when the screen is swiped, and allows the players to quickly focus on the game object.

A method for displaying information in a virtual scene provided in the embodiments of this application is described in detail. Referring to FIG. 9, FIG. 9 is a schematic diagram of hierarchical display of information according to an embodiment of this application. HUD information of a virtual scene is hierarchically processed into three layers, that is, a “prompt information layer”, an “information display layer”, and a “basic operation layer”. (1) The “prompt information layer” and the “information display layer” are used to display scene auxiliary information of the virtual scene, specifically, auxiliary information (such as a prompt of obtaining a virtual item) of a prompt type of the scene auxiliary information is displayed through the “prompt information layer”, and auxiliary information (such as health point information, a task panel, and a chat panel of the virtual object) of a non-prompt type of the scene auxiliary information is displayed through the “information display layer”. (2) The “basic operating layer” is used to display the operation control of the virtual scene, such as a foresight, a movement joystick, a skill button, and a jump button.

Referring to FIG. 8, (1) Before the swipe operation, a full amount of HUD information is displayed on the interface of the virtual scene. (2) In the process of the screen swipe operation, the UI opacity (in an actual implementation, a values of the opacity may be configured) of the “prompt information layer” and the “information display layer” is decreased to adjust the visibility of the scene auxiliary information in the display HUD information, so that the visibility of the scene auxiliary information is lower than the visibility of the operation control, and the Ul of the “basic operation layer” is preserved. This facilitate the players to quickly operate the response. (3) After the swipe operation ends, the UI (that is, the auxiliary information of the non-prompt type of the scene auxiliary information) of the “information display layer” is restored from being displayed, and an initial status before the swipe operation is restored.

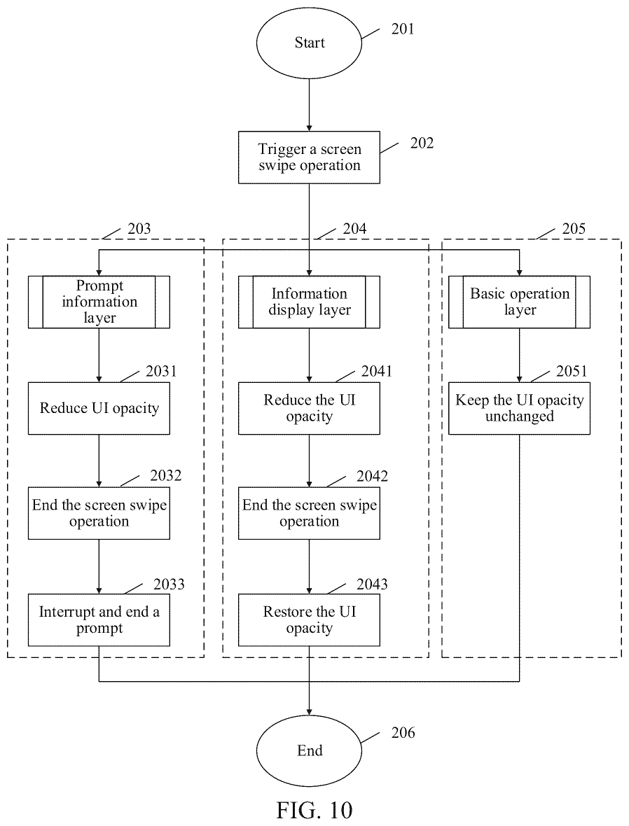

Referring to FIG. 10, a method for displaying information in a virtual scene provided in the embodiments of this application is continued to be described. FIG. 10 is a schematic flowchart of a method for displaying information in a virtual scene according to an embodiment of this application. The method for displaying the information in the virtual scene provided in the embodiments of this application includes:

Operation 201: Start.

Operation 202: Trigger a screen swipe operation.

Operation 203: For a prompt information layer: Operation 2031: Reduce UI opacity. Operation 2032: End the screen swipe operation. Operation 2033: Interrupt and end a prompt.

Operation 204: For an information display layer: Operation 2041: Reduce the UI opacity. Operation 2042: End the screen swipe operation. Operation 2043: Restore the UI opacity.

Operation 205: For a basic operation layer: Operation 2051: Keep the UI opacity unchanged.

Operation 206: End.

In an actual implementation, (1) HUD information is divided into three layers: the “prompt information layer”, the “information display layer”, and the “basic operation layer”. The “prompt information layer” is popped-up prompt information, and is located at an uppermost layer of an interface. The “basic operation layer” is information needed by players to operate and control, and is located at the bottommost layer of the interface. Remaining UI information is the “information display layer” and is located between the “prompt information layer” and the “basic operation layer”.

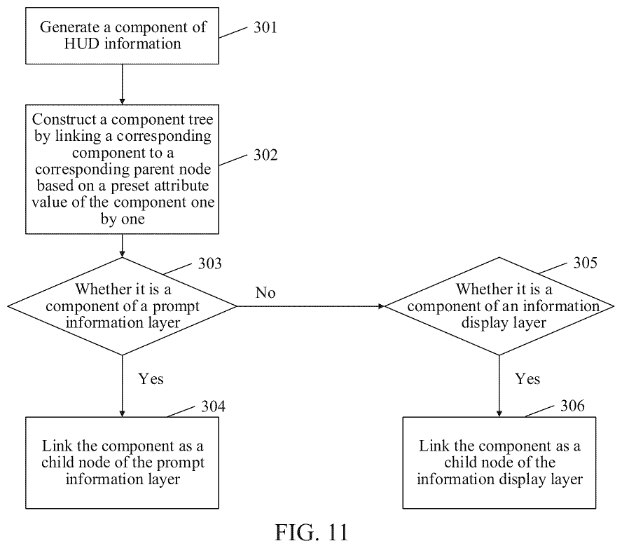

In (1), a hierarchical procedure of the HUD information is shown in FIG. 11. FIG. 11 is a hierarchical flowchart of information of a virtual scene according to an embodiment of this application, including: Operation 301: Generate a component of the HUD information. Operation 302: Construct a component tree by linking a corresponding component to a corresponding parent node based on a preset attribute value of the component one by one. Operation 303: Determine whether it is a component of the prompt information layer. If yes, perform operation 304; and if no, perform operation 305. Operation 304: Link the component as a child node of the prompt information layer. Operation 305: Determine whether it is a component of the information display layer. If yes, perform operation 306. Operation 306: Link the component as a child node of the information display layer.

(2) The foregoing screen swipe operation is configured to turn a virtual camera of the virtual scene to adjust content in a field of view of a virtual object. During the screen swipe operation, UI information of the “basic operation layer” is not processed, and there is no need to reduce the UI opacity. UI information of the “prompt information layer” and the “information display layer” needs to reduce the UI opacity (a specific value may be configured) to adjust visibility of scene auxiliary information in the HUD information.

(3) When the screen operation ends, if the UI information belongs to the “prompt information layer”, the prompt is interrupted and ended. If the UI information belongs to the “information display layer”, the UI opacity needs to be restored to the UI opacity before the screen swipe operation.

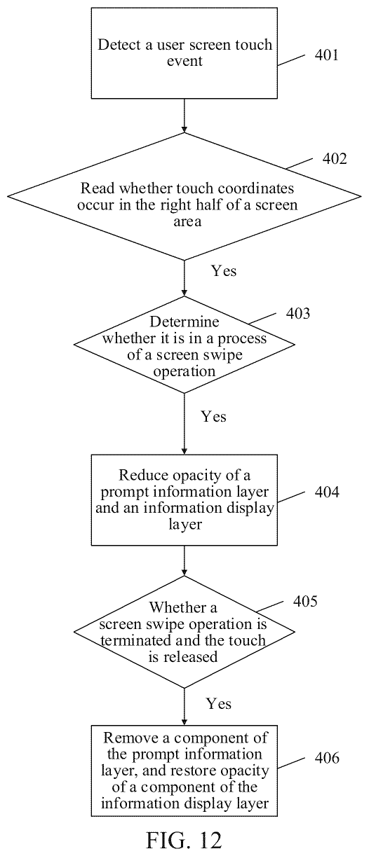

In (2), a procedure of the screen swipe operation is shown in FIG. 12. FIG. 12 is a schematic flowchart of a screen swipe operation according to an embodiment of this application. Operation 401: Detect a user screen touch event. Operation 402: Read whether touch coordinates occur in the right half of a screen area. If yes, perform operation 403. Operation 403: Determine whether it is in a process of a screen swipe operation. If yes, perform operation 404. Operation 404: Reduce opacity of the prompt information layer and the information display layer. Operation 405: Determine whether the screen swipe operation is terminated the touch is released. If yes, perform operation 406. Operation 406: Remove a component of the prompt information layer, and restore opacity of a component of the information display layer. In other words, the component opacity of the information display layer is restored to opacity before the screen swipe operation.

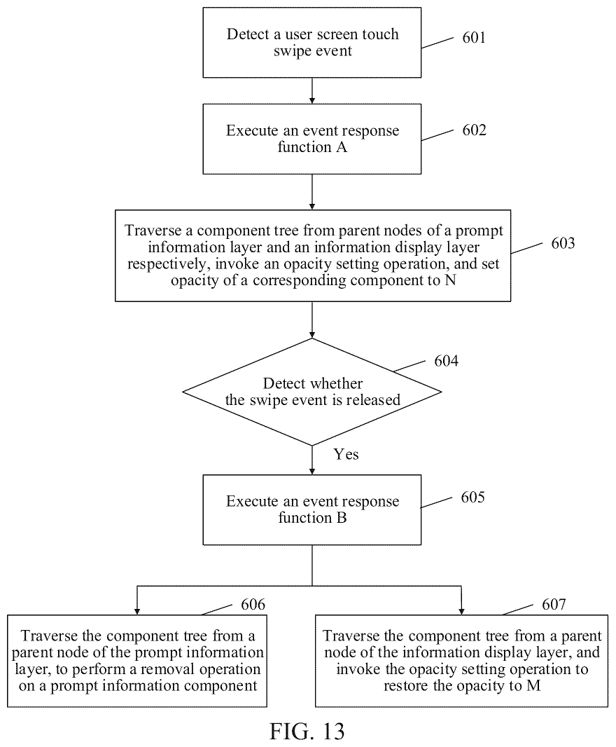

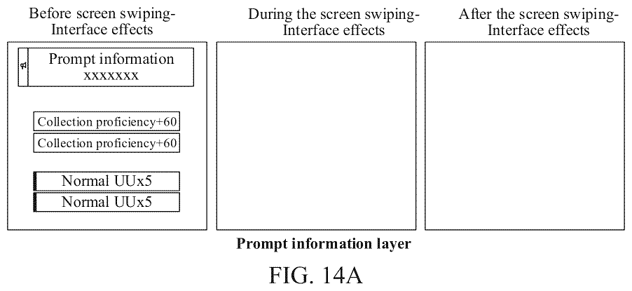

In (2) to (3), an adjusting procedure of the opacity is shown in FIG. 13. FIG. 13 is a schematic flowchart of adjusting opacity according to an embodiment of this application, including: Operation 601: Detect a user screen touch swipe event. Operation 602: Execute an event response function A. Operation 603: Traverse the component tree from parent nodes of the prompt information layer and the information display layer respectively, invoke an opacity setting operation, and set opacity of a corresponding component to N. Operation 604: Detect whether the swipe event is released. If yes, perform operation 605. Operation 605: Execute an event response function B. Operation 606: Traverse the component tree from a parent node of the prompt information layer, to perform a removal operation on a prompt information component. Operation 607: Traverse the component tree from a parent node of the information display layer, and invoke the opacity setting operation to restore the opacity to M.

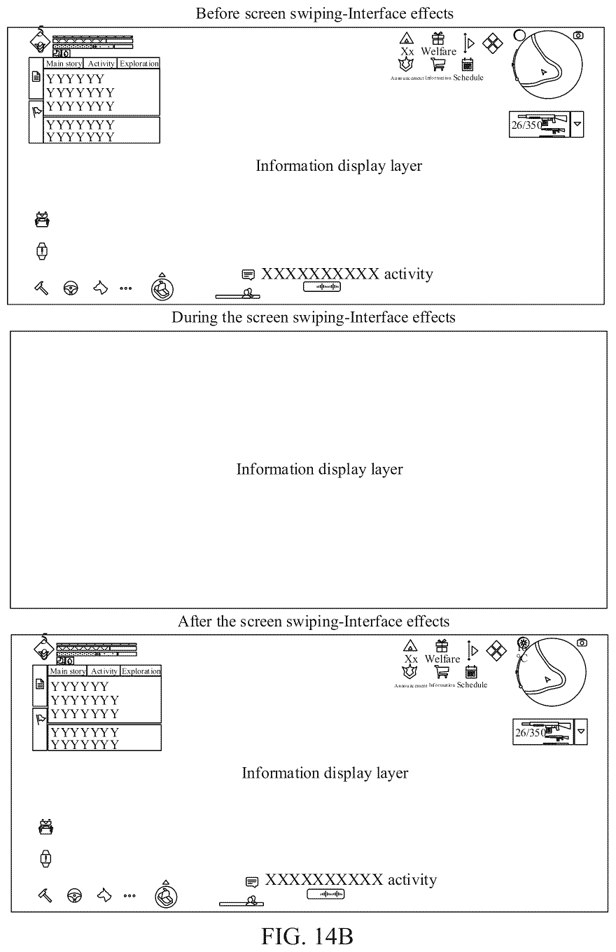

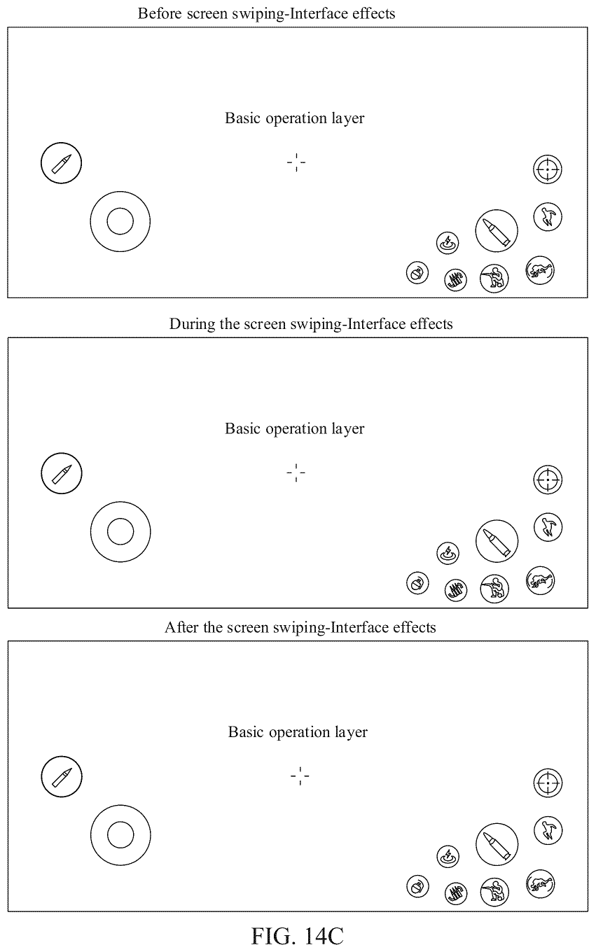

Referring to FIG. 14A to FIG. 14C, FIG. 14A is a schematic diagram of displaying a prompt information layer according to an embodiment of this application. Before a screen swipe operation, scene auxiliary information of a prompt type is displayed through a prompt information layer. During the screen swipe operation, the scene auxiliary information of the prompt type is not displayed on the prompt information layer. After the screen swipe operation ends, the scene auxiliary information of the prompt type is removed, to be specific, the scene auxiliary information of the prompt type is not displayed on the prompt information layer.

FIG. 14B is a schematic diagram of displaying an information display layer according to an embodiment of this application. Before a screen swipe operation, scene auxiliary information of a non-prompt type is displayed through an information display layer. During the screen swipe operation, the scene auxiliary information of the non-prompt type is not displayed on the information display layer. After the screen swipe operation ends, the scene auxiliary information of the non-prompt type is displayed through the information display layer.

FIG. 14C is a schematic diagram of displaying a basic operation layer according to an embodiment of this application. Before a screen swipe operation, during the screen swipe operation, and after the screen swipe operation ends, an operation control is displayed through the basic operation layer.

The foregoing embodiments of this application is used to reduce interference caused by complex HUD information on operations in a virtual scene, and display concise HUD information to players, facilitate to focus on game objectives. In addition, the players may further automatically interrupt interference of pop-up prompt information by using a screen swipe operation, to implement a quick screen clearing purpose.

In the embodiments of this application, when the embodiments of this application are applied to a specific product or technology, data related to user information, such as collection, use, and processing of the related data need to comply with the laws, regulations, and standards of related countries and regions.

The following continues to describe an exemplary structure in which implementation of an apparatus 553 for displaying information in a virtual scene provided in the embodiments of this application is a software module. In some embodiments, as shown in FIG. 2, the software module in the apparatus 553 for displaying the information in the virtual scene stored in a memory 550 may include: a first display module 5531, configured to: display scene auxiliary information of the virtual scene, and display an operation control of the virtual scene, the operation control being configured to control an action of a virtual object in the virtual scene; a second display module 5532, configured to: adjust, in response to an adjustment operation of a field of view, content in the field of view of the virtual object in the virtual scene; and adjust visibility of the scene auxiliary information in a process of adjusting the content adjusted visibility of the scene auxiliary information being lower than visibility of the operation control; and a third display module 5533, configured to restore the visibility of the scene auxiliary information when the adjustment operation of the field of view ends.

In some embodiments, the second display module 5532 is further configured to: receive a swipe operation performed on an interface of the virtual scene, the swipe operation being configured for adjusting the content in the field of view of the virtual object by swiping content of the virtual scene displayed on the interface; and determine the swipe operation as the adjustment operation of the field of view.

In some embodiments, the second display module 5532 is further configured to display a turning control configured to control an orientation of the virtual object; and receive a turning operation for the virtual object and triggered based on the turning control, and determine the turning operation as the adjustment operation of the field of view.

In some embodiments, the first display module 5531 is further configured to display the scene auxiliary information of the virtual scene through a first displaying layer of a view layer, and display the operation control of the virtual scene through a second displaying layer that is independent of the first displaying layer the scene auxiliary information comprising at least one of the following: prompt information configured for prompting an event or an status in the virtual scene, and entrance information of an auxiliary function of the virtual scene.

In some embodiments, the first display module 5531 is further configured to display the operation control of the virtual scene at preset transparency. The second display module 5532 is further configured to adjust transparency of the scene auxiliary information to target transparency higher than the preset transparency.

In some embodiments, the scene auxiliary information includes auxiliary information of a prompt type and auxiliary information of a non-prompt type. The first display module 5531 is further configured to display the auxiliary information of the prompt type and the auxiliary information of the non-prompt type. Correspondingly, the second display module 5532 is further configured to restore visibility of the auxiliary information of the non-prompt type.

In some embodiments, the scene auxiliary information includes a plurality of pieces of auxiliary information. The second display module 5532 is further configured to: obtain scene data of the virtual scene and interaction data of the virtual object; invoke a first neural network model based on the scene data and the interaction data, to predict to-be-adjusted auxiliary information of the plurality of pieces of auxiliary information, to obtain a prediction result; and adjust visibility of auxiliary information indicated by the prediction result.

In some embodiments, the scene auxiliary information includes a plurality of pieces of auxiliary information. The second display module 5532 is further configured to: determine a similar historical virtual scene of the virtual scene for the virtual object, a similarity between the similar historical virtual scene and the virtual scene being greater than a similarity threshold; obtain usage data for the scene auxiliary information in a process of adjusting content in the similar historical virtual scene; and determine to-be-adjusted target auxiliary information from the plurality of pieces of auxiliary information based on the usage data, and adjust visibility of the target auxiliary information.

In some embodiments, there are a plurality of operation controls. The second display module 5532 is further configured to: obtain interaction data of the virtual object and scene data of the virtual scene; invoke a second neural network model based on the interaction data and the scene data, and predict a to-be-used operation control of the plurality of operation controls, to obtain a prediction result; and when the prediction result indicates that the to-be-used operation control is a first operation control, adjust visibility of a second operation control, adjusted visibility of the second operation control being lower than visibility of the first operation control, and the second operation control being an operation control other than the first operation control of the plurality of operation controls.

In some embodiments, there are a plurality of operation controls. The second display module 5532 is further configured to: determine a similar historical virtual scene of the virtual scene for the virtual object, a similarity between the similar historical virtual scene and the virtual scene being greater than a similarity threshold; determine a first operation control whose usage frequency is lower than a frequency threshold in a process of adjusting the content in the similar historical virtual scene; and adjust visibility of the first operation control, adjusted visibility of the first operation control being lower than visibility of a second operation control, and the second operation control being an operation control other than the first operation control of the plurality of operation controls.

In some embodiments, the first display module 5531 is further configured to: display information intelligent display switch of the virtual scene; and in response to an on instruction for the information intelligent display switch, control an information display mode of the virtual scene to be an information intelligent display mode. Correspondingly, the second display module 5532 is further configured to: when the information display mode of the virtual scene is the information intelligent display mode, adjust the visibility of the scene auxiliary information in the process of adjusting the content.

In some embodiments, the second display module 5532 is further configured to: display a display function option for the scene auxiliary information; and when receiving a trigger operation for the display function option, restore the visibility of the scene auxiliary information.

In some embodiments, the scene auxiliary information includes a plurality of pieces of auxiliary information. The first display module 5531 is further configured to: display a selection control corresponding to each auxiliary information; and in response to a selection operation for target auxiliary information triggered based on the selection control, determine the target auxiliary information as the scene auxiliary information displayed in the process of adjusting the content. Correspondingly, the second display module 5532 is further configured to adjust visibility of auxiliary information other than the target auxiliary information of the plurality of pieces of auxiliary information.

In some embodiments, the scene auxiliary information has a display state and a hidden state. The display state is configured to indicate to display the scene auxiliary information, and the hidden state is configured to indicate to hide the scene auxiliary information. The first display module 5531 is further configured to control the scene auxiliary information to be in the display state. Correspondingly, the second display module 5532 is further configured to control the scene auxiliary information of the virtual scene to be adjusted from the display state to the hidden state.

The embodiments of this application is applied. The scene auxiliary information of the virtual scene and the operation control configured to control an action of the virtual object in the virtual scene are displayed. When the adjustment operation of the field of view is received, in the virtual scene, the content in the field of view of the virtual object is adjusted. In addition, in the process of adjusting the content, the visibility of the scene auxiliary information is adjusted, so that the visibility of the scene auxiliary information is lower than the visibility of the operation control. The visibility of the scene auxiliary information is restored when the adjustment operation of the field of view ends. In this way, when the control operation is performed on the virtual scene, the visibility of the scene auxiliary information may be adjusted, so that the visibility of the scene auxiliary information is lower than the visibility of the operation control. Therefore, (1) complexity of information display can be reduced, and utilization of display resources is improved; (2) a user is enabled to focus more on the operation control and the virtual scene. This facilitates the user to quickly control the action of the virtual object based on the operation control, to improve human-computer interaction efficiency and utilization of hardware processing resources.

The embodiments of this application further provide a computer program product. The computer program product includes computer-executable instructions or a computer program. The computer-executable instructions or the computer program is stored in a computer-readable storage medium. A processor of an electronic device reads the computer-executable instructions or the computer program from the computer-readable storage medium, and the processor executes the computer-executable instructions or the computer program, so that the electronic device performs a method for displaying information in a virtual scene provided in the embodiments of this application.

The embodiments of this application further provide a non-transitory computer-readable storage medium. The computer-readable storage medium stores computer-executable instructions. When the computer-executable instructions are executed by a processor, the processor may perform a method for displaying information in a virtual scene provided in the embodiments of this application.

In some embodiments, the computer-readable storage medium may be a memory such as an FRAM, a ROM, a PROM, an EPROM, an EEPROM, a flash memory, a magnetic surface memory, an optical disc, or a CD-ROM, or may be various devices including one or any combination of the foregoing memories.

In some embodiments, the computer-executable instructions may be written in any form of programming language (including a compiled or interpreted language, or a declarative or procedural language) in a form of a program, software, a software module, a script, or code, and may be deployed in any form, including being deployed as an independent program or being deployed as a module, a component, a subroutine, or another unit applicable for use in a computing environment.

For example, the computer-executable instructions may, but do not necessarily correspond to a file in a file system, and may be stored as a part of a file that saves another program or data, for example, stored in one or more scripts in a hypertext markup language (HTML) file, stored in a single file dedicated to a program in discussion, or stored in a plurality of collaborative files (for example, files that store one or more modules, subprograms, or code parts).

For example, the computer-executable instructions may be deployed to be executed on one electronic device, or executed on a plurality of electronic devices located at one location, or executed on a plurality of electronic devices that are distributed in a plurality of locations and interconnected by a communication network.

In sum, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module. The foregoing descriptions described above are merely examples of the embodiments of this application, and this is not intended to limit the protection scope of this application. Any modification, equivalent replacement, and improvement made within the spirit and scope of this application shall fall within the protection scope of this application.

What is claimed is:

1. A method for displaying information in a virtual scene performed by an electronic device, the method comprising:
displaying scene auxiliary information of the virtual scene and an operation control of the virtual scene, the operation control being configured to control an action of a virtual object in the virtual scene;
while adjusting content in a field of view of the virtual object in response to an adjustment operation of the field of view of the virtual object through the operation control:
adjusting visibility of the scene auxiliary information, wherein the adjusted visibility of the scene auxiliary information is lower than visibility of the operation control; and
restoring the visibility of the scene auxiliary information when the adjustment operation of the field of view ends.

2. The method according to claim 1, wherein the method further comprises:
displaying a turning control configured to control an orientation of the virtual object; and
receiving a turning operation for the virtual object triggered based on the turning control as the adjustment operation of the field of view.

3. The method according to claim 1, wherein the scene auxiliary information of the virtual scene is displayed through a first displaying layer of a view layer and the operation control of the virtual scene is displayed through a second displaying layer that is independent of the first displaying layer.

4. The method according to claim 1, wherein the scene auxiliary information comprises:
prompt information configured for prompting an event or a status in the virtual scene, and entrance information of an auxiliary function of the virtual scene.

5. The method according to claim 1, wherein the adjusting visibility of the scene auxiliary information comprises:
adjusting transparency of the scene auxiliary information to a target transparency higher than a preset transparency while keeping the operation control of the virtual scene at the preset transparency.

6. The method according to claim 1, wherein the scene auxiliary information comprises auxiliary information of a prompt type and auxiliary information of a non-prompt type;
the restoring the visibility of the scene auxiliary information comprises:
restoring visibility of the auxiliary information of the non-prompt type without restoring visibility of the auxiliary information of the prompt type.

7. The method according to claim 1, wherein the adjusting visibility of the scene auxiliary information comprises:
obtaining scene data of the virtual scene and interaction data of the virtual object;
invoking a first neural network model based on the scene data and the interaction data, to predict target auxiliary information of a plurality of pieces of scene auxiliary information, to obtain a prediction result; and
adjusting visibility of the target auxiliary information indicated by the prediction result.

8. The method according to claim 1, wherein the adjusting visibility of the scene auxiliary information comprises:
determining a historical virtual scene for the virtual object that is similar to the virtual scene;
determining target auxiliary information from a plurality of pieces of auxiliary information based on interaction data for the scene auxiliary information when adjusting content in the historical virtual scene; and
adjusting visibility of the target auxiliary information.

9. The method according to claim 1, wherein the method further comprises:
determining a historical virtual scene for the virtual object that is similar to the virtual scene;
determining a first operation control whose usage frequency is lower than a frequency threshold in a process of adjusting the content in the historical virtual scene; and
adjusting visibility of the first operation control to be lower than visibility of a plurality of operation controls other than the first operation control.

10. The method according to claim 1, wherein after the adjusting visibility of the scene auxiliary information, the method further comprises:
displaying a display function option for the scene auxiliary information; and
restoring the visibility of the scene auxiliary information in response to a trigger operation for the display function option.

11. The method according to claim 1, wherein the method further comprises:
displaying a selection control of each of a plurality of pieces of scene auxiliary information;
in response to a selection operation for target auxiliary information triggered based on the selection control, determining the target auxiliary information as the scene auxiliary information displayed in the process of adjusting the content; and
the adjusting visibility of the scene auxiliary information comprises:
adjusting visibility of auxiliary information other than the target auxiliary information of the plurality of pieces of auxiliary information.

12. The method according to claim 1, wherein the displaying scene auxiliary information of the virtual scene comprises:
controlling the scene auxiliary information of the virtual scene to be in a display state; and
the adjusting visibility of the scene auxiliary information comprises:
controlling the scene auxiliary information of the virtual scene to be adjusted from the display state to a hidden state.

13. An electronic device, the electronic device comprising:
a memory, configured to store computer-executable instructions; and
a processor, configured to, when executing the computer-executable instructions stored in the memory, implement a method for displaying information in a virtual scene, the method including:
displaying scene auxiliary information of the virtual scene and an operation control of the virtual scene, the operation control being configured to control an action of a virtual object in the virtual scene;
while adjusting content in a field of view of the virtual object in response to an adjustment operation of the field of view of the virtual object through the operation control:
adjusting visibility of the scene auxiliary information, wherein the adjusted visibility of the scene auxiliary information is lower than visibility of the operation control; and
restoring the visibility of the scene auxiliary information when the adjustment operation of the field of view ends.

14. The electronic device according to claim 13, wherein the method further comprises:
displaying a turning control configured to control an orientation of the virtual object; and
receiving a turning operation for the virtual object triggered based on the turning control as the adjustment operation of the field of view.

15. The electronic device according to claim 13, wherein the scene auxiliary information of the virtual scene is displayed through a first displaying layer of a view layer and the operation control of the virtual scene is displayed through a second displaying layer that is independent of the first displaying layer.

16. The electronic device according to claim 13, wherein the scene auxiliary information comprises:
prompt information configured for prompting an event or a status in the virtual scene, and entrance information of an auxiliary function of the virtual scene.

17. The electronic device according to claim 13, wherein the adjusting visibility of the scene auxiliary information comprises:
adjusting transparency of the scene auxiliary information to a target transparency higher than a preset transparency while keeping the operation control of the virtual scene at the preset transparency.

18. The electronic device according to claim 13, wherein the scene auxiliary information comprises auxiliary information of a prompt type and auxiliary information of a non-prompt type;
the restoring the visibility of the scene auxiliary information comprises:
restoring visibility of the auxiliary information of the non-prompt type without restoring visibility of the auxiliary information of the prompt type.

19. The electronic device according to claim 13, wherein the adjusting visibility of the scene auxiliary information comprises:
obtaining scene data of the virtual scene and interaction data of the virtual object;
invoking a first neural network model based on the scene data and the interaction data, to predict target auxiliary information of a plurality of pieces of scene auxiliary information, to obtain a prediction result; and
adjusting visibility of the target auxiliary information indicated by the prediction result.

20. A non-transitory computer-readable storage medium, having computer-executable instructions stored therein, wherein the computer-executable instructions, when executed by a processor of an electronic device, cause the electronic device to implement a method for displaying information in a virtual scene, the method including:
displaying scene auxiliary information of the virtual scene and an operation control of the virtual scene, the operation control being configured to control an action of a virtual object in the virtual scene;
while adjusting content in a field of view of the virtual object in response to an adjustment operation of the field of view of the virtual object through the operation control:
adjusting visibility of the scene auxiliary information, wherein the adjusted visibility of the scene auxiliary information is lower than visibility of the operation control; and
restoring the visibility of the scene auxiliary information when the adjustment operation of the field of view ends.
